(19) United States
(12) Patent Application Publication
(10) Pub. No.: US 2006/0022006 A1
(43) Pub. Date: Feb. 2, 2006

(54) Universal Suspended Collapsible Interframe Carrier for Bottles, Cups, Beverages and Sundries for Wheeled Luggage, and Method

(76) Inventor: Tom Cruise, Bettendorf, IA (US)

Correspondence Address: TOM CRUISE, 2617 LINCOLN ROAD, BETTENDORF, IA, 52722, US

(21) Appl. No.: 11/163,821

(22) Filed: Nov. 1, 2005

Related U.S. Application Data
(60) Provisional application No. 60/522,731, filed on Nov. 1, 2004.

(51) Int. Cl. A45C 3/00; B60R 11/00; B60R 9/00

(52) U.S. Cl. 224/572; 190/108

(57) ABSTRACT

A collapsible carrier attached by means of adhesion (12,15,13,16) whereby a suspension system (18) allows the carrier to remain perpendicular to planar gravity as the luggage invokes motion by the user and rotates through the variable angle beta (FIG. 5) during motion or at rest. Said carrier is of sufficient size to hold various items, and is especially suited for liquids, including beverages. The carrier resides between the handles of the wheeled luggage (FIG. 1) and is generally collapsible to eliminate the need for removal upon stowing the luggage or collapsing the extended handle.(1)

### BACKGROUND

This invention relates to wheeled luggage, specifically to beverage holders that are free-moving, and that do not require a lot of additional space for storage of said holder when not in use. Wheeled luggage is prolific in our society today. Nearly every piece of wheeled luggage has a retractable handle for ease of motion when extended. Since Sep. 11, 2001 all airlines have increased their restrictions for carry-on items, specifically limiting the size and amount of materials that a passenger may bring aboard the aircraft. To date, there has been no efficient nor convenient way to carry a water bottle (or other beverage or sundry items) without adding additional baggage. The vast majority of these bags do not have an adequate way to store a beverage container, without the container itself becoming more baggage and bulk. Ott, in U.S. Pat. No. 6,390,431 has created such a device, which is of rigid and bulky design outside of the luggage; it creates another piece of bulk to be stowed inside the bag when not in use, thus limiting the usable space inside of the wheeled luggage during flight.

### DESCRIPTION

The item of specification is a removably attached, or permanently affixed, receptacle of consumable beverage, or sundry items, which holds said items upright by means of suspension, occupying the space vertically between the handle and luggage body, laterally between the extension members while the handle is extended on wheeled luggage, employing the use of gravity and a suspension system to keep the container in the upright position. As the wheeled luggage is moved off center to begin motion, the device allows the beverage container, or items within, to remain in a vertical and upright position due to the free-moving interplay of the suspension arms.

The device is made of any suitable material; thin, lightweight, durable cloth is currently being employed and is supported by four elongated segments (segment quantity can vary) suspended from the handle of the luggage in the area between the distal and proximal supporting members of the handle. The device is created from two nearly single-plane, trapezoidal-shaped pieces of material, with the larger area at the top or mouth.

Each piece of material has two protruding arms that are integral to each singular side, which comprise the longitudinal dimension of the suspension arms. The trapezoidal shapes can be adhered by various means, but generally sewn with thread on the bottom, fore and aft dimensions, leaving the top open. The suspension arms are not sewn together, except for a slight lateral projection near the attachment points of the arms that is used for stabilization under the handle.

The device is attached by means of the four suspension arms adhering in connection over the top of the handle (two on each side) by some means of adhesion, whereas hook and loop fasteners are the most common but snaps or other fasteners could easily be employed, including mechanical connections.

The position of the suspension arms is near the outer dimensions of the handle, which therefore allows the owner to hold fast to the handle during pedestrian movement with wheeled luggage.

When not in use, the device may easily be stowed in luggage pocket or baggage; it may be wrapped and secured neatly around the handle with sufficient clearance to be compressed with the telescopic distal and proximal arms back into the body of the luggage, or simply draped over the bag after retraction of the telescopic handle down into the luggage.

The unique trapezoidal shape allows many variations in size, shape, and height of containers to remain in an upright, secure, and easily accessible position, during motion or at rest, but other shapes could be used. The two-dimensional nature of the device allows it to quickly and easily conform to three-dimensional objects, and hold the general shape for sufficient duration to allow for the efficient egress and ingress of the beverage container, or other items.

### DRAWINGS

FIG. 1 is a perspective frontal view of the bottle holder with bottle suspended with the wheeled luggage at rest.

FIG. 2 is perspective fontal view of the entire bottle holder showing the attachment areas with hook and loop fasteners, and cut-away section of the lower portion of the holder

FIG. 3 is a perspective side view of the suspension arms showing the attachment points, the lateral projection between the suspension arms and the hook and loop fasteners

FIG. 4 is a perspective side view of the handle of the luggage with the suspension arms attached over the handle.

FIG. 5 is a perspective view of the wheeled luggage with bottle holder attached and demonstrating the angular position of the luggage in motion with the bottle holder in its self-righting position which keeps the contents of the bottle holder in a vertical and upright position.

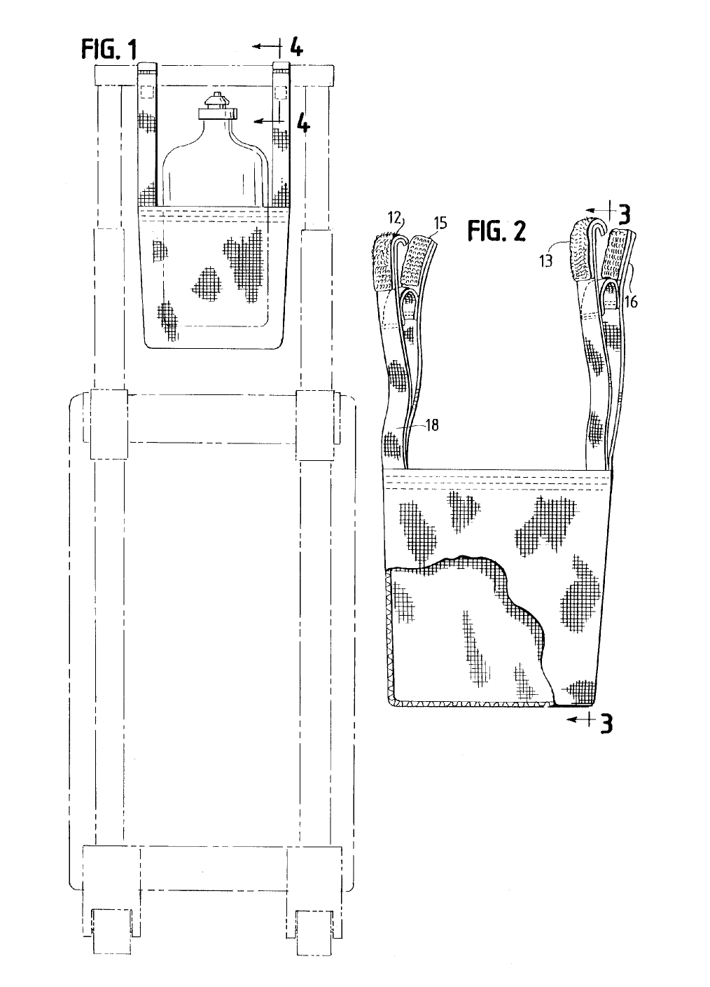

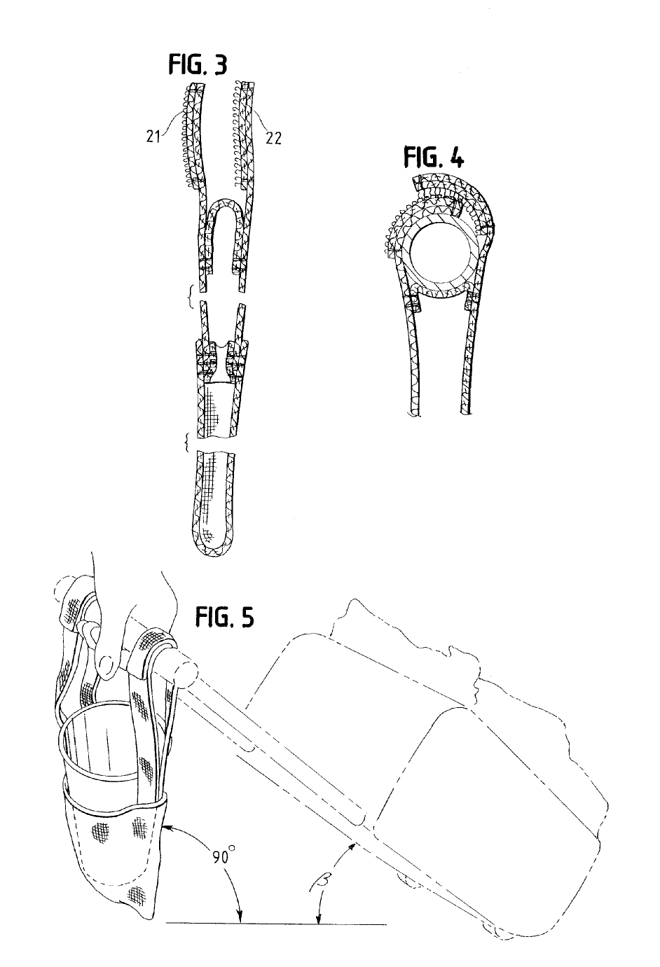

### SUMMARY

In accordance with the present invention a bottle, cup, or sundries holder comprising of a suspension system that allows free moving interplay and self-righting capabilities while conforming to the contents of said holder, that is easily collapsible and removable, attached to the handle, and occupies the interior space of the handle, extension rods, and upper surface of wheeled luggage created when the retractable handle is fully deployed to its elongated position.

What is claimed is:

1. An article of luggage for holding objects perpendicular to planar gravity comprising:
(a) wheeled Luggage with extendable handle
(b) suspension system from handle, either removable attached or permanently fixed
(c) affixed suspended body of approximate size between anterior and posterior handle extensions allowing free moving interplay with gravity.
